(19) United States
(12) Patent Application Publication
(10) Pub. No.: US 2003/0094723 A1
(43) Pub. Date: May 22, 2003

(54) Method of making an improved preform

(76) Inventor: Kurt H. Ruppman SR., Dallas, TX (US)

Correspondence Address: THE LAW OFFICES OF H. DENNIS KELLY, 2401 TURTLE CREEK, DALLAS, TX, 75219, US

(21) Appl. No.: 09/683,106

(22) Filed: Nov. 19, 2001

(51) Int. Cl. B29C 45/00

(52) U.S. Cl. 264/85; 264/328.1; 264/523; 425/542; 428/542.8

(57) ABSTRACT

Commercially available polyester-based resin that has been stored in ambient air is dried in an oxygen-depleted atmosphere, then heated to a temperature above the melting point and injected into a preform mold. Heating and injection molding of the resin is preferably conducted in an atmosphere substantially devoid of oxygen. Preforms made using the method exhibit reduced acetaldehyde levels compared to conventional methods.

### TECHNICAL FIELD

This invention relates in general to making preforms for use in blowing plastic containers. In particular, the invention relates to a method of making an injection-molded polyester-based plastic preform having reduced absorbed oxygen and acetaldehyde levels.

### BACKGROUND OF INVENTION

Manufacturers of polyethylene terephthalate (PET) containers have sought to reduce levels of acetaldehyde (AA) in the finished product since PET was first used to make food and drink containers. Acetaldehyde is bothersome because even in trace amounts it can ruin the taste of the edible contents. This problem is especially acute for beverages such as water, beer and sodas, and prompted the Coca Cola company to devise what has become a de facto standard test for acceptable levels of AA, appropriately known as the Coca Cola standard. In the test, the interior of a newly manufactured container is flushed with an inert gas. The container is then sealed and stored for 24 hours (usually at 20° C.), after which time the AA content of the gas in the container is measured and usually expressed in units of micrograms of AA per liter of gas. Coca Cola set an upper limit of 3 micrograms per liter to ensure acceptable taste of the bottle contents. Different limits have been set for other beverages.

Acetaldehydes are created not only during polymerization of the raw PET, but also during the injection molding of preforms, and to a lessor extent in the subsequent blow molding of the preform into the final container. The primary causes of AA formation during the preform stage are commonly believed to be thermal degradation of the molten PET along with shear stresses that arise from the screw feeder in the injection molding equipment.

U.S. Pat. No. 4,230,819, issued to Hauenstein et al. on Oct. 28, 1980, discloses a process for removing aldehydes from crystalline PET by contacting the PET with dry air or nitrogen at a temperature between about 170° C. to 250° C. for several hours, during which time aldehydes are removed. Carbon dioxide is listed as an alternative drying gas. The crystalline resin was prepared by drying amorphous PET resin having an IV (intrinsic viscosity) of 0.59 and crystallizing by heating at about 240° C. for an undisclosed time. The PET was formed into a bed about 36 inches thick prior performing the disclosed drying process. Final AA content varied from 7.8 ppm to 1.5 ppm, with lower numbers corresponding to higher drying temperatures.

Kadykowski reports in “How to Dry the TP Polyesters,” Plastics Technology, November 1977, pp. 103-106 that while inert gas has been used to dry PET resin to prevent discoloration, improvements in drier design allow drying to be performed using dry air. Kadykowski also suggests that longer drying times are required to reduce AA levels than are required to dry the resin. Residence times of 8-10 hours at 350° F. are listed. The creation of acetaldehyde during injection molding in noted, but is considered to be unimportant if AA formation is minimized during the drying stage.

It is common practice in the molding industry to dry the PET resin with heated dry air prior to injection molding in order to remove absorbed water in the PET. Absorbed water is generally believed to break the polymer chains into shorter pieces during molding, reducing the intrinsic viscosity of the resin below acceptable levels. PET resin is normally sold in pellet form and is predominantly amorphous, with only the surface layer crystallized to prevent the pellets from sticking together during storage and drying. (Amorphous PET resin is clear, pure crystalline PET is opaque white. When the crystallinity of PET resin gets too high, the resin becomes cloudy, making it unsuitable for use in bottles.) The drying temperatures disclosed in Hauenstein et al. cannot be used with this kind of resin, because unacceptable thermal breakdown occurs, even for much shorter drying times than the 8 hour drying time used in Hauenstein et al. In fact, AA content has been shown to increase when the higher temperatures used in Hauenstein et al. are used to dry commercially available PET. Commercial drying practice has therefore failed to show the reduced AA levels of Hauenstein et al.

U.S. Pat. No. 5,648,032, issued to Nelson et al. discloses a method of making a molded polyester article where the resin is partially polymerized, then pelletized and stored. The pellets are then remelted and formed into the article. The method makes use of a devolatilization step at one or more points along the way by passing the polymer through a screw-feed extruder having vents to allow a purging agent to pass over the polymer to remove acetaldehyde and other volatiles.

U.S. Pat. No. 5,656,719, issued to Stibal et al. discloses a method of injection molding PET into a preform for eventual blow molding into a bottle. The method includes taking a polyester melt having an IV in the range of 0.5 to 0.75 dl/g (this range of IV is generally recognized as being suitable for textiles but not for making bottles) and processing the melt in a post-condensation reactor, simultaneously lowering the AA content below 10 ppm and raising the IV to 0.75 to 0.95 dl/g (generally recognized as bottle grade PET), and immediately processing the melt into preforms by injection molding. The post-condensation reactor uses a melt-flow screw extruder operated under vacuum to remove AA and other volatile components. Preferably, an inert gas is injected into the melt prior to introducing it to the reactor, in order to promote bubble formation which is claimed to improve the removal of volatile components by increasing surface area of the melt during expansion in the extruder. While nitrogen, argon, and helium are listed as candidates for the inert gas, supercritical carbon dioxide is preferred and is claimed to extract acetaldehyde from the PET, a property that is further claimed to be previously unknown. The use of carbon dioxide to remove AA is also disclosed in U.S. Pat. No. 4,764,323 issued to Al Ghatta, where subcritical carbon dioxide vapor is used to remove AA from finished preforms.

U.S. Pat. No. 5,980,797, issued to Shelby et al. discloses another method of making a molded polyester article, where the polymer is not solidified and stored at any intermediate stage, but is taken directly from the production stage, mixed with a stripping agent and sent to a flash tank, where AA is removed. The molten polymer is then pumped out of the flash tank and into an injection molding machine to form the finished article.

The prior art methods generally use gas purging to remove AA formed as a byproduct of polymerization of lower molecular weight polyester molecules into the longer molecular chains required for making bottles. Since at least part of each method involves polymer production, the prior art methods require substantial additional equipment over and above the conventional injection molding equipment. Many plastic container manufacturers are reluctant to invest the capital and the floor space to add this equipment to their plants. A method that can be performed on commercially available, post-production polymer resin would be more attractive from an economic standpoint.

Acetaldehyde is created during the polymerization process using oxygen present in the polymer precursors themselves. Thus, AA will be created during polymerization regardless of the presence of absorbed oxygen, or free oxygen in the atmosphere contacting the polymer. It occurred to this inventor that the acetaldehyde created during post-production processing (drying, injection molding, etc.) is not due to further polymerization, but is instead the result of the PET resin reacting with free oxygen, either in the air contacting the PET resin or as molecular oxygen that becomes absorbed by the resin from prolonged contact with ambient air during storage. Therefore, removing any loosely bound oxygen from the resin, and preventing free oxygen from contacting the PET during molding, should reduce AA levels in the preform. This could be achieved with a minimal modification to conventional equipment. Low product AA concentrations such as those claimed for the Hauenstein et al. method could be achieved without the need for drying temperatures that would melt commercially available PET resin. The method could also reduce AA without the need for special catalysts, stripping agents, or other AA reducing compounds added to the resin.

### SUMMARY OF INVENTION

In general, a method having the desired features and advantages is achieved using a conventional drying hopper/injection molding apparatus, with only minor modifications to the drying hopper in the form a small gas line connected near the outlet base of the drying hopper. The gas line supplies an inert gas into the equipment. Nitrogen gas is preferred as the inert gas, but any gas that displaces oxygen and does not react adversely with the polyester-based PET resin can be used. The inert gas should not contain significant quantities of impurities that would also react adversely. Some suitable gases include carbon dioxide (but not the typical commercial grades that contain water vapor or other undesirable impurities), argon, and chlorofluorocarbons. The inert gas flows into the drying hopper and into a screw feeder fed by the drying hopper. The injection of the inert gas results in an oxygen-depleted atmosphere in the drying hopper, and substantially displaces oxygen from equipment downstream of the drying hopper. After the drying step, the resin is heated above the melting temperature so that it will flow, and injection molded into a preform. The resin in the post-drying steps contacts an oxygen-depleted atmosphere, and preferably contacts an atmosphere that is substantially devoid of oxygen, thereby reducing or preventing creation of acetaldehyde. The method of the invention is conventional in all critical respects with the exception of the use of the inert gas as just described.

The method of the invention does not require the additional equipment of prior art methods, thereby minimizing capital costs. Since the method of the invention is predominantly the same as methods presently in use for drying and molding PET resin, almost no training is required for a person of ordinary skill in the art in order to practice the method of the invention. No specialized catalysts, stripping agents or exotic polymer blends are required to achieve reduced AA levels. Also, since AA is prevented from forming in the screw feeder, there is no need for a specialized screw feeder having venting connections as taught in the Nelson et al. patent previously discussed. However, such a screw feeder could be used if desired.

### BRIEF DESCRIPTION OF DRAWINGS

Additional features and advantages of the invention will become apparent in the following detailed description and in the single drawing FIGURE, which shows a preferred apparatus for carrying out the method of the invention.

### DETAILED DESCRIPTION

The term “polyester-based resin” as used herein means a solid resin suitable for injection molding and having at least one polyester polymer, either alone or in combination with one or more other polymers with the polyester constituting at least about 50 percent by weight of the resin. The other polymers can be polyester, either copolymers or nonhomologous polyesters, or nonpolyester polymers. PETG and PETN are examples of possible copolymers, while polyethylene, polypropylene and polyamides are examples of possible nonpolyester polymers.

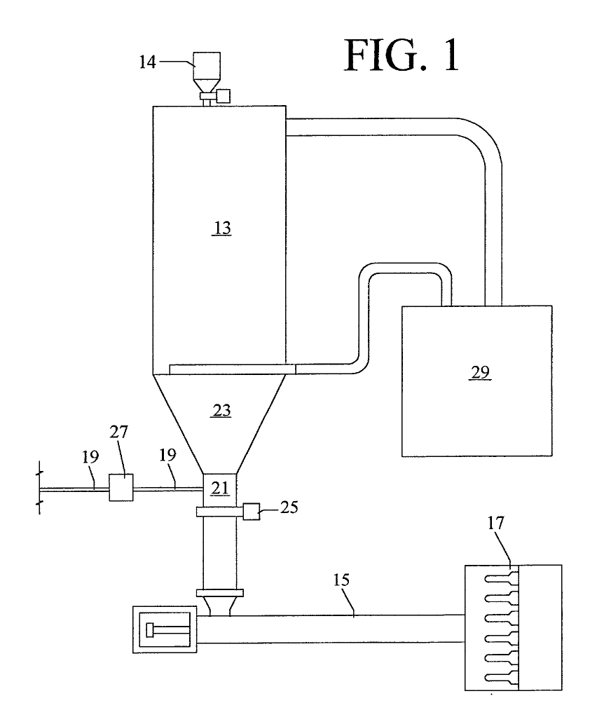

FIG. 1 schematically shows a preferred apparatus used to carry out the method of the invention. The apparatus 11 includes a drying hopper 13 connected to a screw feeder 15 that in turn feeds a multiple cavity injection molding machine 17. A commercial scale pilot plant is producing 1500 lb/hr (680 kg/hr) of PET preforms. The equipment is conventional with one exception: a gas line 19 is fitted to the short stand pipe section 21 located between the bottom of the drying hopper feed cone 23 and the outlet shutoff valve 25. A pressure regulator 27 regulates the supply of nitrogen gas an provides the means for injecting the nitrogen into the drying hopper 13. The pressure regulator 27 can be set over a wide range: values ranging from 2 to 30 psig (13.8 to 206.8 kpag) have been used in the pilot plant, but higher pressures are contemplated. A manual or automatic flow control loop can be used in place of the pressure regulator 25, as well as other means known in the art for injecting a gas into a process.

Prior to the first step, the drying hopper 13 is loaded with polyester-based PET resin. Typically, an initial inventory is loaded into the drying hopper 13, and a minimum inventory is then maintained in the drying hopper 13 using a control system (not shown) based on resin level or weight. To maintain inventory in the drying hopper 13, a small loading hopper 14 is located above the drying hopper 13 and filled periodically from a remote resin silo (not shown). When the loading hopper 14 is filled, the inlet to the hopper is closed and the loading hopper dumps its inventory into the drying hopper 13. Each time the loading hopper 14 dumps, the ambient atmosphere trapped in the loading hopper 14 mixes with the atmosphere in the drying hopper 13. Otherwise, the drying hopper 13 with its associated equipment operates as a pseudo-closed system, so the average flow rate of nitrogen through the gas line 19 is relatively small. Normally, oxygen is not completely flushed from the drying hopper 13. However, experimentation has shown improvement in AA levels even when oxygen is present in the drying hopper 13 atmosphere as high as 17.5 volume percent. Throughout this reference, the term “oxygen-depleted atmosphere” is defined as an atmosphere containing less than about 17.5 volume percent oxygen.

The residence time for resin in the drying hopper ranges from about 3 hours to about 5 hours, depending on the drying temperature used. Dehumidifying equipment 29 dehumidifies and heats the circulating atmosphere. Drying time and temperature are set in accordance with standard practice in the industry. Typical drying temperatures range from about 120° C. to about 170° C., with higher temperatures generally corresponding to shorter residence times. Measurable improvement in AA levels will likely occur even without the use of heating, but heating is strongly preferred not only to accelerate the release of absorbed oxygen, but also to remove absorbed water.

Drying takes place in an oxygen-depleted atmosphere to help release any oxygen that may be loosely bound to the surface of the PET resin, or trapped in bubbles in the resin. Obviously, the lower the percentage of oxygen in the oxygen-depleted atmosphere, the better. A rough indication of how much oxygen is present in the polymer is given by the oxygen release test set out in test procedure ASTM 1945.

An alternative embodiment having several variations is envisioned, in which the drying hopper 13 is systematically purged of most or all of the oxygen in the gas inside the drying hopper 13. This purging can occur in either batch or continuous fashion, and can be performed as needed using a manual or automatic control loop to maintain a desired oxygen concentration in the drying hopper 13. Purging can be achieved by employing a vent located distal to the gas line connection at a point on the drying hopper 13 or its associated drying equipment. This embodiment can theoretically lower the oxygen level in the drying hopper down to zero, but requires more extensive modifications to existing equipment, and consumes more of the inert gas.

Following the drying step, the PET resin is dumped into the screw feeder, where the injection molding steps can begin. Heating elements (not shown) located in the screw feeder 15 raise the temperature of the PET resin above the melting point, so that it will flow sufficiently well to permit it to be injected into a mold. A few initial test injection cycles are normally performed on a new batch of PET resin to ensure the quality of the resulting preforms. With each injection cycle, an amount of gas can travel into the screw feeder along with the resin. This gas is believed to be almost completely comprised of the purge gas from the gas line 19, since the higher pressure in the gas line 19 will cause most of the gas downstream of the injection point to be supplied by the gas line 19. This will be especially true for heavier-than-air gases such as carbon dioxide that stratify easily, thereby ensuring that air/oxygen is displaced from piping below the injection point. Therefore, the PET resin contacts an atmosphere somewhere between an oxygen-depleted atmosphere and an atmosphere substantially devoid of oxygen. As a practical guideline, “substantially devoid of oxygen” is defined as containing less than about one volume percent oxygen.

The following example will serve to illustrate the features and advantages of the method of the invention.

### EXAMPLE

An initial inventory of about 6600 pounds (3.0 metric tons) of commercial bottle grade PET resin was loaded into a Piovan T3000IX drying hopper and dried at 170° C. with a residence time of about 4 hours. After drying, the hot dried resin was fed into a Husky G500PET P100/120 E120 injection molding machine with 32 mold cavities, which was used to produce roughly 1500 lb/hr (680 kg/hr) of molded preforms for beverage bottles. Two separate production runs were conducted, one without nitrogen injection (i.e. ambient air in the hopper and downstream equipment), and the other with nitrogen injection to obtain an average drying hopper oxygen concentration of 15.1 volume percent. For each run, samples were collected of: (1) the cold resin (from storage), (2) the hot, dried resin leaving the drying hopper, (3) preforms made from the dried resin, and (4) bottles made from the preforms. The bottle were manufactured using a conventional Sidel cold blowing method, but nitrogen gas was used for blowing the bottle rather than compressed air. The oxygen content was measured for all four samples in accordance with the ASTM 1945 test standard. AA levels in the preform were not measured on the preforms themselves, but a head space gas test was conducted on samples of the finished bottles, and the acetaldehyde level was determined using a Perkin Elmer Autosystem XL gas chromatograph. Table 1 lists the results of the two production runs:

TABLE 1

| Measured Quantity | Production Run 1 | Production Run 2 |
|---|---|---|
| Hopper O₂ Conc., vol. % | 21.4 | 15.1 |
| Cold Resin O₂, cc/gram | 0.022 | 0.022 |
| Hot Resin O₂, cc/gram | 0.070 | 0.015 |
| Preform O₂, cc/gram | 0.024 | 0.013 |
| Bottle O₂, cc/gram | 0.064 | 0.016 |
| Bottle AA, μg/liter | 3.1 | 0.009 |

the use of nitrogen gas injection to lower the drying hopper oxygen concentration resulted in significant drops both in absorbed oxygen and in the acetaldehyde level, even though oxygen concentration in the drying hopper was more than 70 percent of ambient air concentration. The extremely low acetaldehyde measurement for the bottle made using the method of the invention was unexpected, and was even considered temporarily to be due to a malfunction of the gas chromatograph! The measurement was confirmed by further tests, however.

A noteworthy side affect of the method is that bottles blown from preforms made using the method of the invention tend to show improved hot filling properties as well as reduced AA levels. Heat filling temperatures as high as 180° F. (82° C.) have been observed for bottles blown using conventional Sidel cold blow molding. It is not known at this time why this additional advantage is achieved.

The method of the invention has several advantages over the prior art. The method can be practiced with minimal and inexpensive adaption of known apparatus, and does not add significant capital or operating costs. The method is virtually identical to conventional drying and injection molding methods, so little or no extra training is required to familiarize operators with the new method. Bottles made using the method have significantly reduced AA levels compared to conventional bottles, and also exhibit improved hot filling properties.

The invention has been shown in one embodiment, with numerous alternate embodiments and variations being described in the text. It should be apparent to those skilled in the art that the invention is not limited to these embodiments and variations, but is capable of being varied and modified without departing from the scope of the invention as set out in the attached claims.

1. A method for making a preform from a polyester-based resin stored at ambient conditions, comprising the steps of:a) reducing the absorbed oxygen in the polyester-based resin by contacting the resin with an oxygen-depleted atmosphere;b) heating the polyester-based resin in an oxygen-depleted atmosphere to a temperature above the melting point until the polyester-based resin can be injection molded;c) creating a preform from the melt by injection molding in an oxygen-depleted atmosphere.

2. The method for making a preform as recited in claim 1, wherein the drying step (a)occurs at a temperature between about 120° C. and about 170° C.

3. The method for making a preform as recited in claim 2, wherein steps (b) and (c) occur in an atmosphere substantially devoid of oxygen.

4. The method for making a preform as recited in claim 2, wherein the drying step (a)occurs in an atmosphere substantially devoid of oxygen.

5. A preform made using the method of claim 1.

6. A preform made using the method of claim 2.

7. A preform made using the method of claim 3.

8. A preform made using the method of claim 4.

9. The method for making a preform as recited in claim 2, further comprising the step, following (c), of blow molding a bottle from the preform.

10. A method for making a preform from a polyester-based resin stored at ambient conditions, comprising the steps of:a) contacting the polyester-based resin with an oxygen-depleted atmosphere at a temperature between about 120° C. and about 170° C. for a predetermined time;b) heating the polyester-based resin in an oxygen-depleted atmosphere to a temperature above the melting point until the polyester-based resin can be injection molded; and c) creating a preform from the melt by injection molding.

11. A method for making a preform as recited in claim 10, wherein step (a) occurs in an atmosphere substantially devoid of oxygen.

12. A method for making a preform as recited in claim 10, wherein step (b) occurs in an atmosphere substantially devoid of oxygen.

13. A preform made using the method of claim 10.

14. A preform made using the method of claim 11.

15. A preform made using the method of claim 12.

16. An apparatus for making a preform from a polyester-based resin stored at ambient conditions, comprising: a) a drying hopper having an outlet;b) an injection molding machine receiving polyester-based resin from the drying hopper outlet; and c) means for injecting an inert gas, connected to the drying hopper near the outlet.

17. An apparatus as recited in claim 16, wherein the means for injecting an inert gas is a gas line and a pressure regulator.
